(19) United States
(12) Patent Application Publication
(10) Pub. No.: US 2015/0172421 A1
(43) Pub. Date: Jun. 18, 2015

(54) DATA COMPRESSION IN A COMMUNICATIONS NETWORK

(71) Applicants: Paul Stjernholm, Lidingo (SE); Hans Eriksson, Sollentuna (SE); Jens Knutsson, Enebyberg (SE); Fredrik Persson, Marsta (SE); Lars Westberg, Enkoping (SE)

(72) Inventors: Paul Stjernholm, Lidingo (SE); Hans Eriksson, Sollentuna (SE); Jens Knutsson, Enebyberg (SE); Fredrik Persson, Marsta (SE); Lars Westberg, Enkoping (SE)

(73) Assignee: Telefonaktiebolaget L M Ericsson (publ), Stockholm (SE)

(21) Appl. No.: 14/407,614

(22) PCT Filed: Jun. 13, 2013
(86) PCT No.: PCT/EP2013/062303

§ 371 Date: Dec. 12, 2014

Related U.S. Application Data
(60) Provisional application No. 61/659,013, filed on Jun. 13, 2012.

(51) Int. Cl. H04L 29/06; H04W 4/18; H04W 28/02

(52) U.S. Cl. CPC H04L 69/04; H04W 28/0226; H04W 4/18

(57) ABSTRACT

A method and apparatus for data compression in a mobile communication network. A node performing data compression on a downlink towards a mobile terminal compresses data based on an identity of a decompression node. A determination is made that the mobile terminal is no longer receiving data from the decompression node owing to mobility the mobile terminal. An identity of a further decompression node from which the mobile terminal receives data is determined, and data is compressed based on the identity of the further decompression node. The node performing compression can therefore dynamically adapt to mobility of the terminal, potentially resulting in a shorter learning phase.

### TECHNICAL FIELD

The invention relates to data compression in a communications network, and in particular to compression of data in a mobile communications network.

### BACKGROUND

When sending data over a communications network, compression is a technique that is used to minimize the bandwidth required by that data in order to make the communications network more efficient. This is particularly important for communications networks that rely on wireless transmission of data. Wireless Area Network (WAN) acceleration/optimization of sending data relies on many different optimization techniques to reduce the bandwidth needed by services when sending data. This improves the Quality of Experience (QoE) for the end user and lowers the network and transmission costs for the network operator.

Compressing the size of data content, using techniques such as de-duplication, may significantly reduce the bandwidth required, and solutions to do this are commercially available.

The process of de-duplication is illustrated in FIG. 1, in which a compressor 1 or a de-compressor 2 identifies byte patterns in a payload of a data stream and associates an identified byte pattern with a shorter index, referred to as a signature. This is done for many byte patterns, leading to many signatures, which are stored in a database. The data payload and the associated signatures are transmitted to the remote side, where the same association is stored in a database. This phase is denoted as the learning phase. At some point in time the de-compressor 2 agrees with the compressor 1 to start sending compressed data over the link. Alternatively, a signature can be assigned to a pattern of bytes as soon as the pattern is repeated. Subsequent byte patterns identified by the compressor 1 are replaced with the corresponding signatures, which are sent over the link. At the de-compressor 2, the signatures are again replaced with the full byte patterns. The original data stream is thus recreated and further processed as normal. Solutions are implemented in the network user plane and do not rely on the control plane.

A compressor 1 typically associates the signatures with a de-compressor 2. The correct signatures may therefore rely on knowledge of the identity of the de-compressor 2 (or compressor 1). It is possible that a compressor 1 may associate a signature with a particular byte pattern for sending the data associated with the byte pattern to a particular de-compressor 2, and associate a different signature to the same byte pattern for sending the data associated with the byte pattern to a different de-compressor.

Existing techniques are typically intended for and designed for static point-to-point or point-to-multipoint deployment, as illustrated in FIG. 2 (depicting an enterprise use case). This shows a node at a central office 3 communicating with fixed nodes at branch offices 4, 5. In this case, the central office node 3 compresses data, sends it to the branch offices 4, 5 which decompress the data. However, this cannot be directly deployed in a mobile network infrastructure if the decompressor is deployed at a level in the mobile network which is affected by mobility, since it cannot adapt to the mobility of a mobile user. The compressor must be aware that the identity of the de-compressor may change dynamically as a user's mobile terminal moves, and the compressor needs to know what signatures can be used when compressing data towards a certain de-compressor.

An alternative solution to cater for mobility is for the de-compressor to notify the compressor of an unknown signature in a session after mobile terminal cell change or handover. The compressor must then reset compression for that session and start the learning phase again. This approach results in compression on a per session basis, which is inefficient as the learning process can take several hours to reach a compression efficiency of 80%.

An alternative solution to account for the mobility of the end-user is to deploy the de-compression in the mobile terminal, i.e. a mobile phone or a mobile tab or laptop, as shown in FIG. 3. In this case a central office node 3 communicates with, for example, any of a mobile phone 6, a laptop computer 7 or a tablet 8, which perform decompression of compressed data. However, this requires deep integration into the mobile devices 6, 7, 8, which is an issue when it comes to deploying it in a mobile network, especially with legacy mobile terminals.

### SUMMARY

It is an object of the invention to address the problems caused by mobile terminal mobility when sending and receiving compressed data. Furthermore, it is an object of the invention to mitigate the problems associated with the relearning phase when an identity of a compressor or decompressor changes owing to mobility of a mobile terminal.

According to a first aspect, there is provided a method of handling data compression in a mobile communication network. A node performing data compression on a downlink towards a mobile terminal compresses data on the basis of an identity of a decompression node. A determination is made that the mobile terminal is no longer receiving data from the decompression node owing to mobility the mobile terminal. The identity of a further decompression node from which the mobile terminal receives data is determined, and data is compressed on the basis of an identity of the further decompression node. An advantage of this is that the node performing compression can dynamically adapt to mobility of the terminal, potentially resulting in a shorter learning phase.

As an option, the node determines that the mobile terminal is no longer attached to the decompression node owing to mobility of the mobile terminal by receiving a mobile network control plane message, the message including an identity of the further decompression node. This allows the node to determine the identity of the further decompression node. As a further option, the mobile network control plane message is selected from at least any of an Update PDP Context Request, a Modify Bearer Request and a Create Session Request. The mobile network control plane message optionally further includes an indication as to whether compression is supported and an identity of the further decompression node.

As an alternative option, the determination that the mobile terminal is no longer attached to the decompression node owing to mobility of the mobile terminal is made by intercepting user plane traffic sent towards the mobile terminal, performing packet inspection on the intercepted user plane traffic, and determining the address of the further decompression node from header information in the intercepted user plane traffic. As a further option, the user plane traffic is on the GTP-U layer.

Optional examples of nodes performing data compression are any of a Gateway GPRS Support Node, a Serving Gateway, a Packet Data Network Gateway and a Serving GPRS Support Node.

Optional examples of the decompression node and the further decompression node are selected from any of an enhanced Node B, a Radio Network Controller, a Serving Gateway, and a Serving GPRS Support Node.

According to a second aspect, there is provided a node for performing data compression on a downlink towards a mobile terminal in a mobile communications network. The node is provided with a processor for compressing data on the basis of an identity of a decompression node. The processor is further arranged to determine that the mobile terminal is no longer attached to the decompression node owing to mobility of the mobile terminal. The processor is further arranged to determine the identity of a further decompression node to which the mobile terminal is attached, and to subsequently compress data on the basis of an identity of the further decompression node.

As an option, the node is optionally provided with a receiver for receiving a mobile network control plane message, the message including an identity of the further decompression node. As a further option, the mobile network control plane message is selected from at least any of an Update PDP Context Request, a Modify Bearer Request and a Create Session Request. The mobile network control plane message optionally includes an indication as to whether compression is supported and an identity of the further decompression node.

As an alternative option, the processor is further arranged to determine that the mobile terminal is no longer attached to the decompression node owing to mobility of the mobile terminal by intercepting user plane traffic sent towards the mobile terminal, performing packet inspection on the intercepted user plane traffic, and determining the address of the further decompression node from header information in the intercepted user plane traffic. As a further option, the user plane traffic is on the GTP-U layer.

Optional examples of the node are a Gateway GPRS Support Node, a Serving Gateway, a PDN Gateway and a Serving GPRS Support Node.

According to a third aspect, there is provided a computer program comprising computer readable code which, when run on a network node, causes the network node to perform the method as described above in the first aspect.

According to a fourth aspect, there is provided a computer program product comprising a non-transitory computer readable medium and a computer program as described above in the third aspect, wherein the computer program is stored on the computer readable medium.

### BRIEF DESCRIPTION OF DRAWINGS

FIG. 1 illustrates schematically in a block diagram a network architecture and signalling for performing de-duplication when sending compressed data;

FIG. 2 illustrates schematically in a block diagram a network architecture and signalling for performing compression when sending compressed data in an enterprise scenario;

FIG. 3 illustrates schematically in a block diagram a network architecture and signalling for performing compression when sending compressed data in an enterprise scenario with a mobile workforce;

FIG. 4 illustrates exemplary compression and decompression locations according to the type of access technology according to embodiments of the invention;

FIG. 5 illustrates schematically an exemplary network architecture and signalling for handover of a UE in an LTE network;

FIG. 6 is a flow diagram showing exemplary steps; and FIG. 7 illustrates schematically in a block diagram an exemplary network node.

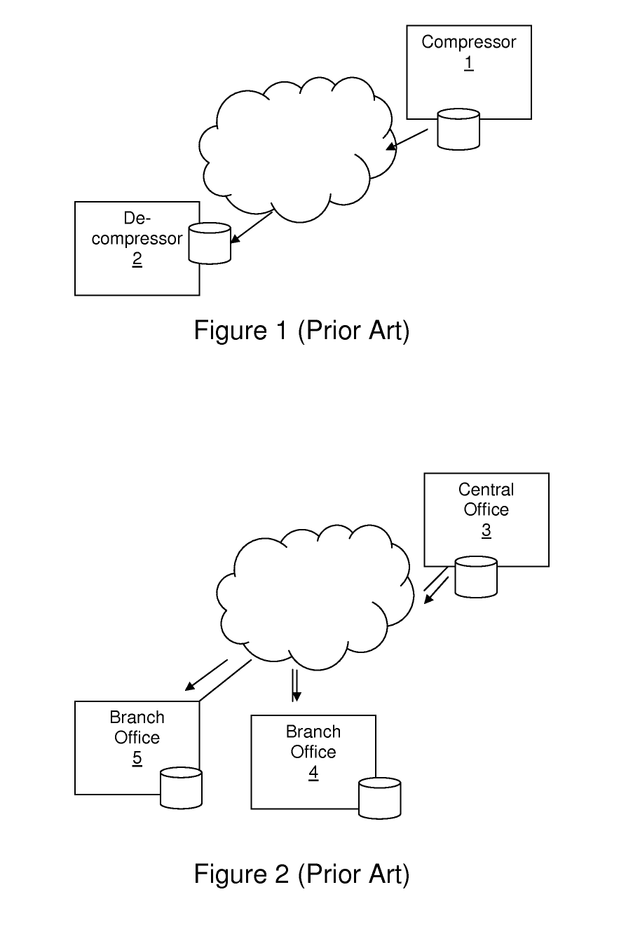

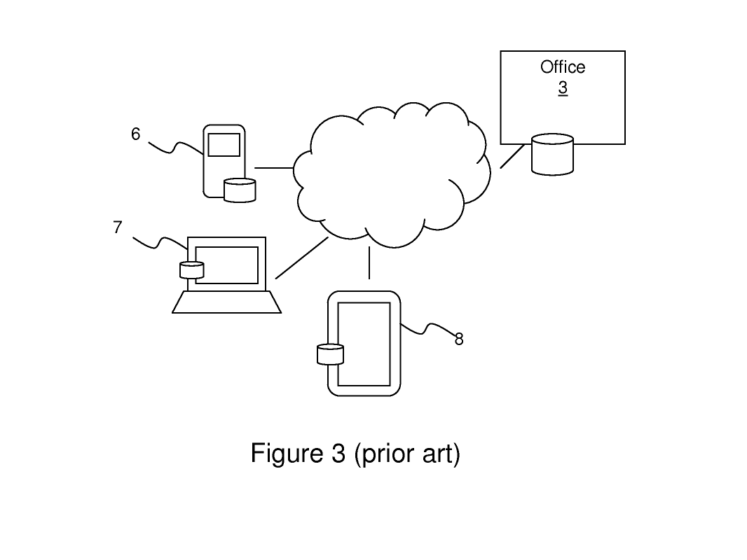

### DETAILED DESCRIPTION

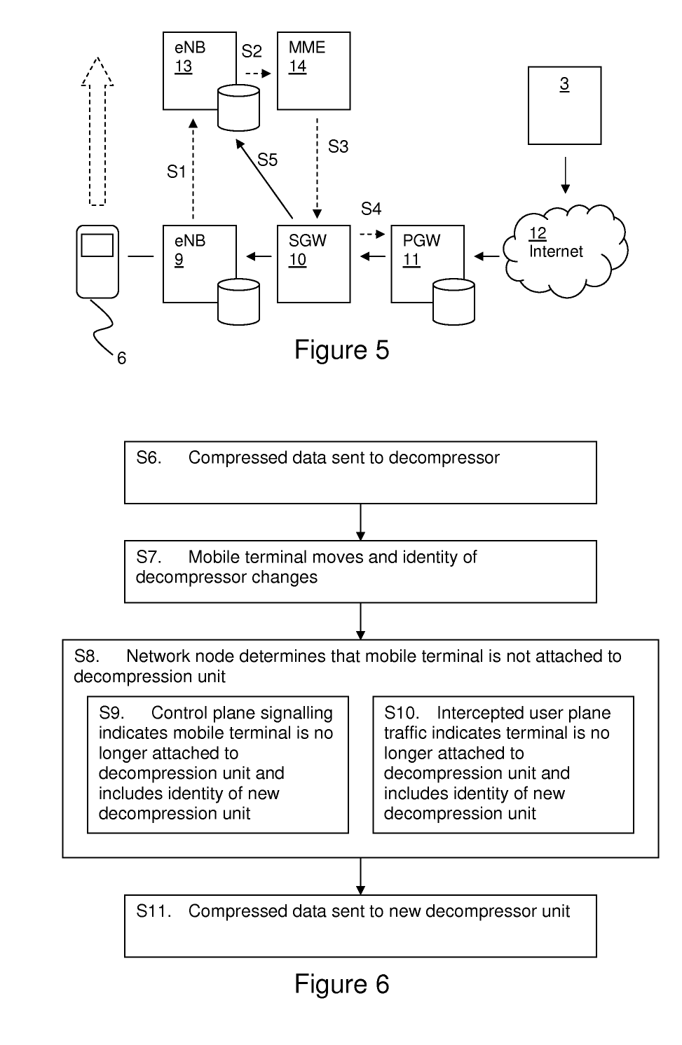

When an instance of a decompressor changes, for example because a mobile terminal 6 has moved from a source Radio Network Controller (RNC) to a target RNC, a compressor is notified this via either mobile network control signalling or by inspection of packet headers (this situation is illustrated in FIG. 5, in which a mobile terminal 6 moves from a source eNodeB 9 to a target eNodeB 13). The compressor may rely on using feedback in the mobile network control plane to notify the compressor of the identity of the de-compressor at each change of de-compressor instance. The notification may need to be relayed across one or more nodes in the mobile network. The notification is triggered by mobility events such as handover and cell change. Alternatively, instead of relying on a notification, the compressor may rely on intercepting user plane traffic to identify when a change of de-compressor occurs. The term “mobile terminal” is used herein to refer to any type of mobile equipment, examples of which are mobile phones, smartphones, laptop computers and so on.

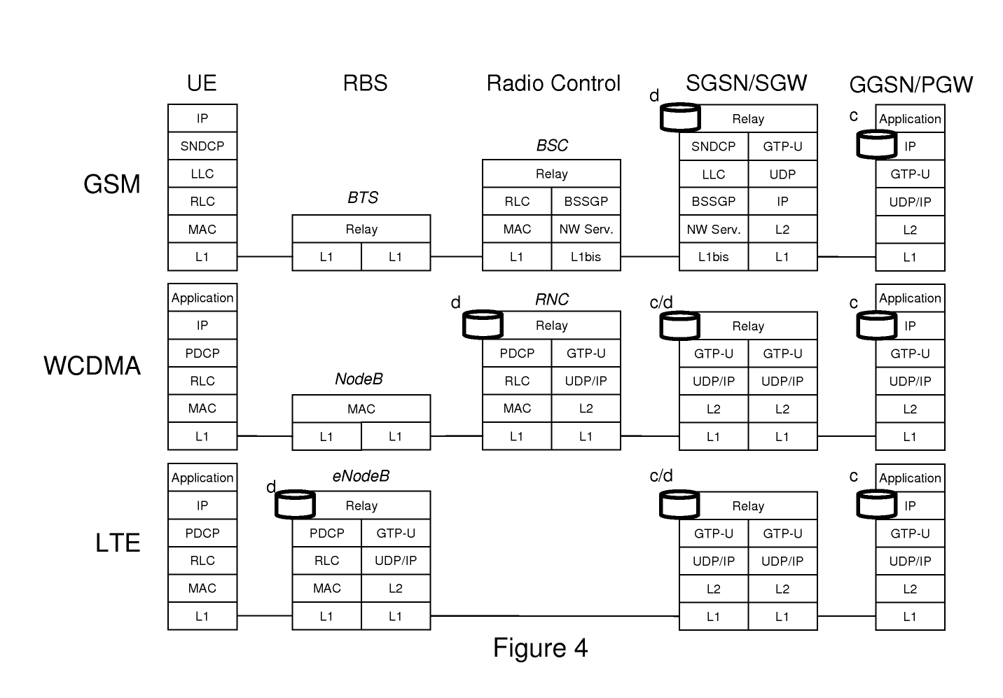

The deployment of compression and decompression may be performed on several levels in the network depending on the technology used. A solution depends on protocol layers on IP level and above being accessible, which disqualifies some nodes, e.g. the Base Transceiver Station (BTS) in GSM. FIG. 4 shows different network nodes for perform compression/decompression operations in different networks. The GGSN/PGW nodes can perform compression, intermediate nodes in WCDMA and LTE can perform either compression or decompression, and the intermediate nodes at the RNC and eNodeB can perform decompression. This assumes a downlink connection, and it will be appreciated that the roles are reversed for an uplink.

To maximize the downlink gains in the mobile network, compression is ideally performed at the ingress at the Gi/SGi interface in the GGSN/PGW and de-compression is performed as close to the air interface as possible. For GSM, this is at the SGSN/SGW, for WCDMA the RNC, and for LTE the eNodeB. This does not prohibit deployment of compression or decompression in any other feasible node.

To avoid repeating the learning phase at handover (e.g. from one RNC to another), the compressor needs to be informed the identity of the de-compressor used, in order to apply the signatures known by the de-compressor. This could be achieved by control signalling (in which the compressor is notified of the change of de-compressor) or by intercepting user plane traffic (in which the new de-compressor can be identified by intercepting traffic and inspecting packet headers).

The following description assumes that only one de-compressor is deployed per node, but it will be appreciated that the techniques can be extended to identify different de-compressors at the same node.

Where control plane signalling is used to notify the compressor of the change in decompressor, the already standardized handover signalling scheme is used to convey information to the compressor of a change in de-compressor at handover or cell change. FIG. 5 illustrates mobility by an example of X2 handover completion procedure in an LTE network in which a mobile device 4 is attached to an eNodeB 9 and communicates with a source 3 of compressed data via a Serving Gateway (SGW) 10, a PDN Gateway (PGW) 11 and the Internet 12. Handover is from the source eNodeB 9 to a target eNodeB 13.

The following numbering corresponds to that of FIG. 5:

S1. User plane data is forwarded to the target eNodeB 13 over an X2 interface.

S2. The target eNodeB 13 sends a Path Switch Request to a Mobility Management Entity (MME) 14 to switch the user plane directly to the target eNodeB 13.

S3. The MME 14 sends a Modify Bearer Request (at intra-SGW handover) or a Create Session Request (at inter-SGW handover) to the SGW 10.

S4. The SGW 10 sends a Modify Bearer Request to the PGW 11 to establish a new GPRS Tunnelling Protocol (GTP)-U tunnel towards the target eNodeB 13.

S5. After the path switch, user plane traffic is sent from the SGW 10 to the target eNodeB 13.

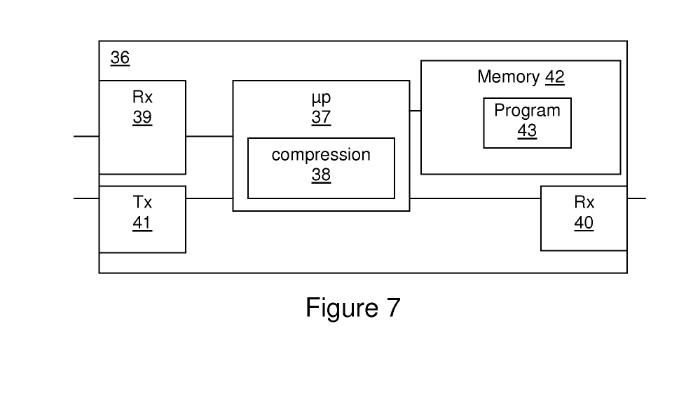

As described above, the PGW 11 may be notified of the change of de-compressor, or may discover the change. FIG. 6 is a flow diagram illustrating the main steps of the two main embodiments described above. The following numbering corresponds to that of FIG. 6:

S6. Compressed data is sent from a compression unit to a decompression unit on a downlink towards a mobile terminal 6.

S7. Mobility of the mobile terminal 6 results in the identity of the decompression unit changing.

S8. The node hosting the compression unit (in the example of FIG. 5, this is the PGW 11) determines that the mobile terminal 6 is no longer receiving data from the decompression unit (in the example of FIG. 5, this is the eNodeB 9).

S9. In the event that the node 11 hosting the compression unit relies on control plane signalling, it receives a mobile network control plane message informing it of the identity of the new decompression unit (in the example of FIG. 5, the target eNodeB 13) to which the mobile terminal 6 is now attached. This may be in the form of an existing Update PDP Context Request, a Modify Bearer Request or a Create Session Request, or in a new Information Element contained in any of those messages. The process continues at step S11.

S10. Alternatively, the node 11 hosting the compression unit intercepts user plane traffic sent towards the mobile terminal, performed packet inspection on the intercepted user plane traffic and determines the identity or address of the new decompression unit using header information in the intercepted user plane traffic.

S11. The node 11 hosting the compression unit compresses data on the basis of the identity of the new decompression unit.

Depending on the location of the compressor, existing 3GPP standards messages may already contain information conveying the location of the de-compressor and, therefore implicitly identify the de-compressor. Table 1 below indicates alternative exemplary locations of the compressor and de-compressor and indicates whether location information is available in 3GPP standardized control messages or not.

TABLE 1
Signalling impact for downlink compression

| | De- | | De-compressor location |
|---|---|---|---|
| Compressor | compressor | 3GPP message to | information available in |
| location | location | compressor node | 3GPP |
| GGSN/PGW | SGSN/SGW | Update PDP | Yes |
| | | Context Request/ | |
| | | Modify Bearer | |
| | | Request | |
| GGSN/PGW | RNC | Update PDP | Partly. NodeB |
| | | Context Request/ | address/identity needs to |
| | | Modify Bearer | be appended when GTP |
| | | Request | direct tunnel is not used. |
| PGW | eNodeB | Modify Bearer | No. eNodeB |
| | | Request | address/identity needs to |
| | | | be appended. |
| SGW | RNC | Modify Bearer | Partly. RNC |
| | | Request/Create | address/identity needs to |
| | | Session Request | be appended when GTP |
| | | | direct tunnel is not used. |
| SGSN | RNC | Update PDP | Yes |
| | | Context Request | |
| SGW | eNodeB | Modify Bearer | Yes |
| | | Request/Create | |
| | | Session Request | |

The messages Modify Bearer Request (intra-SGW), Create Session Request (inter-SGW) and Update PDP Context may be involved in mobility procedures affecting the compression function. Note that these are not always involved and that are be mobility procedures where messages are not affected (e.g. Forward Relocation Request), or where a compression function is not affected (for example, where they are executed below the downlink de-compressor).

As an example, an exemplary Serving Radio Network Subsystem (SRNS) relocation procedure is shown in FIG. 39, “SRNS Relocation Procedure” in 3GPP TS 23.060, General Packet Radio Service (GPRS); Service description; Stage 2 (12.0.0). In this Figure, a Mobile Station (MS) moves from a source RNC to a target RNC, the RNCs being served by different SGSNs and in which a GGSN compresses data sent towards the MS. The Update PDP Context Requests may be used to send information affecting compression operations.

As a further example, an X2-based handover without a SGW relocation procedure is shown in FIG. 10.1.2.1.1-1, “Intra-MMEServing Gateway HO” in 3GPP TS 36.300, Evolved Universal Terrestrial Radio Access (E-UTRA) and Evolved Universal Terrestrial Radio Access Network (E-UTRAN); Stage 2 (11.5.0). A User Equipment (UE) moves from a source eNodeB to a target eNodeB, and a PGW compresses data which is sent via a SGW. In this example, Modify Bearer Request messages may be used to send information affecting compression operations.

As a further example, an X2-based handover with a SGW relocation procedure is shown in FIG. 5.5.1.1.3-1, “X2-based handover with Serving GW relocation” in 3GPP TS 23.401, “General Packet Radio Service (GPRS) enhancements for Evolved Universal Terrestrial Radio Access Network (E-UTRAN) access (12.0.0). Again, Modify Bearer Request messages and Create Session Request messages may be used to send information affecting compression operations.

As a further example, an exemplary GERAN AGb mode handover is shown in FIG. 10, “PS Handover Execution Phase; Inter-SGSN case (GERAN AGb mode a GERAN AGb mode)” in 3GPP TS 43.129, Technical Specification Group GSMEDGE Radio Access Network; “Packet-switched handover for GERAN AGb mode”. Update PDP Context Request messages may be used to send information affecting compression operations.

An exemplary UTRAN to E-UTRAN lu mode Inter RAT handover procedure is shown in FIG. 5.5.2.2.3-1, “UTRAN lu mode to E-UTRAN Inter RAT HO, execution phase” in 3GPP TS 23.401, “General Packet Radio Service (GPRS) enhancements for Evolved Universal Terrestrial Radio Access Network (E-UTRAN) access (12.0.0)”. The nodes involved are a UE, a source RNC, a target eNodeB, a source SGSN, a target MME, a source SGW, a target SGW, a PGW and a HSS. Modify Bearer Request messages may be used to send information affecting compression operations.

In order to implement control plane signalling without having to amend 3GPP standards, existing control signalling messages can be used, depending on the locations of the compressor/de-compressor, as shown in Table 1. Examples are Update PDP Context Request, Modify Bearer Request and Create Session Request. These require a GTP direct tunnel, which requires support throughout the network.

Additionally, new Information Elements (IE) are added to the signalling control messages Update PDP Context Request, Modify Bearer Request and Create Session Request indicating whether compression is supported and the identity or location of the remote side de-compressor. However, this would require modification of existing 3GPP standards such as 3GPP TS 23.060, General Packet Radio Service (GPRS); Stage 2 and 3GPP TS 23.401, General Packet Radio Service (GPRS) enhancements for Evolved Universal Terrestrial Radio Access Network (E-UTRAN) access.

As mentioned above, the compressor may be notified of a change in instance of a decompressor by user plane interception of packets. Solutions based on intercepting the user plane are currently deployed at the IP layer, but not on the GTP-U layer. FIG. 4 shows that at the potential compression/de-compression locations, the IP layer is encapsulated in the GTP-U protocol. This indicates that user plane interception to notify the compressor of a change in instance of the decompressor requires that packet inspection is capable of handling GTP-U.

In order to use GTP-U to inform the compressor of the change in instance of the de-compressor, the GTP-U header must include at least the address of the node at which the de-compressor is located.

The endpoints of GTP tunnels in a GSM network are the SGSN and the GGSN. The endpoints of GTP tunnels in a WCDMA network are the GGSN, the SGSN and the RNC. The endpoints of GTP tunnels in an LTE network are the PGW, the SGW and the eNodeB. The applicability of end-points in the Core Network depends on whether GTP direct tunnelling is configured or not.

FIG. 7 illustrates a network node 36 according to embodiments of the invention. The node 36 comprises a processor 37 that operates a compression function 38. The processor 37 compresses data on the basis of the identity of the decompression unit (located, for example, at an RNC) to which the compressed data is sent. When the processor 37 determines that the mobile terminal 6 is no longer receiving data from the decompression unit owing to mobility of the mobile terminal 6, it determines the identity of a further decompression unit (located, for example, at a new RNC) to which the mobile terminal 6 is attached. The processor 37 subsequently compresses data on the basis of an identity of the further decompression unit.

In the control plane embodiment described above, the node 36 is provided with a receiver 39 for receiving a mobile network control plane message that includes an identity of the further decompression unit.

In the user plane traffic embodiment described above, the node 36 is provided with a second receiver 40 for receiving user plane traffic. The processor 37 is arranged to determine that the mobile terminal 6 is no longer receiving data from the decompression unit node owing to mobility of the mobile terminal by intercepting user plane traffic sent towards the mobile terminal, performing packet inspection on the intercepted user plane traffic, and determining the address of the further decompression node from header information in the intercepted user plane traffic, which can then be sent using a transmitter 41.

A non-transitory computer readable medium in the form of a memory 42 may also be provided, which can be used to store a program 43. The program 43, when executed by the processor 37, causes the network node 36 to behave as described above.

The techniques described above allows implementing compression techniques such as de-duplication on IP level in the user plane of a mobile network, by deploying compression and de-compression in mobile network nodes. The solution allows the downstream compressor to dynamically adapt to changes of the de-compressor due to the mobility of the mobile terminal. It relies on either already existing mobility control messages in the control plane, or alternatively inspection of the GTP-U headers. The former alternative provides a more flexible solution.

Network based content compression as described above is advantageous for session based de-compression or de-compression in a mobile terminal. It provides a larger compression gain due to a shorter learning phase, since the de-compressor learns from more data streams. It also has no impact on mobile terminals.

It will be appreciated by the person of skill in the art that various modifications may be made to the above described embodiment without departing from the scope of the present invention. For example, the functions of the network node are described as being embodied at a single node, but it will be appreciated that different functions may be provided at different network nodes. Furthermore, where a single functional entity such as a processor is described, it will be appreciated that the functions of that processor may be performed by different physical processors. The above description gives the example of compression information comprising a byte pattern and associated signature. It will be appreciated that the techniques described above may apply to other types of compression information, such as compression information arising from compression techniques such as data differencing.

The following acronyms have been used in the above description:
DL Downlink
eNodeB enhanced Node B
GGSN Gateway GPRS Support Node
GPRS General Packet Radio Service
GTP GPRS Tunnelling Protocol
HSS Home Subscriber Server
IE Information Elements
LTE Long Term Evolution
MME Mobility Management Entity
Mobile Station (MS)
OAM Operation and Maintenance
PDN Packet Data Network
PGW PDN Gateway
QoE Quality of Experience
RAN Radio Access Network
RIM RAN Information Management
RNC Radio Network Controller
SGW Serving Gateway
SGSN Serving GPRS Support Node
SRNS Serving Radio Network Subsystem
SI Signalling Information
SIB Signalling Information Block
TCP Transport Control Protocol
UE User Equipment
UL Uplink
WAN Wireless Area Network
WCDMA Wideband Code Division Multiple Access

1. A method at a node for handling data compression in a mobile communication network, the method comprising:
performing data compression on a downlink towards a mobile terminal;
compressing data based on an identity of a decompression node;
determining that the mobile terminal is no longer receiving data from the decompression node owing to mobility of the mobile terminal;
determining an identity of a further decompression node from which the mobile terminal receives data; and
compressing data on based on the identity of the further decompression node.

2. The method according to claim 1, further comprising:
determining that the mobile terminal is no longer attached to the decompression node owing to mobility of the mobile terminal by receiving a mobile network control plane message, the message including the identity of the further decompression node.

3. The method according to claim 2, wherein the mobile network control plane message is one of an Update Packet Data Protocol (PDP) Context Request, a Modify Bearer Request, and a Create Session Request.

4. The method according to claim 3, wherein the mobile network control plane message further includes an indication as to whether compression is supported and the identity of the further decompression node.

5. The method according to claim 1, further comprising:
determining that the mobile terminal is no longer attached to the decompression node owing to mobility of the mobile terminal by:
intercepting user plane traffic sent towards the mobile terminal;
performing packet inspection on the intercepted user plane traffic; and
determining an address of the further decompression node from header information in the intercepted user plane traffic.

6. The method according to claim 5, wherein the user plane traffic is on a General Packet Radio Service (GPRS) Tunneling Protoco (GTP) User (GTP-U) layer.

7. The method according to claim 1, wherein the node performing data compression is one of a Gateway General Packet Radio Service (GPRS) Support Node, a Serving Gateway, a Packet Data Network Gateway, and a Serving GPRS Support Node.

8. The method according to claim 1, wherein the decompression node and the further decompression node is one of an enhanced Node B, a Radio Network Controller, a Serving Gateway, and a Serving General Packet Radio Service (GPRS) Support Node.

9. A node for performing data compression on a downlink towards a mobile terminal in a mobile communications network, the node comprising:
a processor arranged to compress data based on an identity of a decompression node;
the processor further arranged to determine that the mobile terminal is no longer attached to the decompression node owing to mobility of the mobile terminal;
the processor further arranged to determine an identity of a further decompression node to which the mobile terminal is attached; and
the processor further arranged to compress data based on the identity of the further decompression node.

10. The node according to claim 9, further comprising:
a receiver arranged to receive a mobile network control plane message, the message including the identity of the further decompression node.

11. The node according to claim 10, wherein the mobile network control plane message is one of an Update Packet Data Protocol (PDP) Context Request, a Modify Bearer Request, and a Create Session Request.

12. The node according to claim 11, wherein the mobile network control plane message further includes an indication as to whether compression is supported and an identity of the further decompression node.

13. The node according to claim 9, wherein the processor is further arranged to determine that the mobile terminal no longer attached to the decompression node owing to mobility of the mobile terminal by intercepting user plane traffic sent towards the mobile terminal, performing packet inspection on the intercepted user plane traffic, and determining an address of the further decompression node from header information in the intercepted user plane traffic.

14. The node according to claim 13, wherein the user plane traffic is on a General Packet Radio Service (GPRS) Tunneling Protocol (GTP) User (GTP-U) layer.

15. The node according to claim 9, wherein the node is one of a Gateway General Packet Radio Service (GPRS) Support Node, a Serving Gateway, a Packet Data Network (PDN) Gateway, and a Serving GPRS Support Node.

16. A non-transitory computer-readable storage medium having computer code stored therein, which when executed by a processor of a network node, cause the network node to perform operations comprising:
performing data compression on a downlink towards a mobile terminal;
compressing data on based on an identity of a decompression node;
determining that the mobile terminal is no longer receiving data from the decompression node owing to mobility of the mobile terminal;
determining an identity of a further decompression node from which the mobile terminal receives data; and
compressing data based on the identity of the further decompression node.

17. (canceled)
